(19) United States
(12) Patent Application Publication
(10) Pub. No.: US 2023/0159760 A1
(43) Pub. Date: May 25, 2023

(54) ISOCYANATE-MODIFIED ASPHALT COMPOSITIONS

(71) Applicants: William J. KIRK, Charlotte, NC (US); BASF SE, Ludwigshafen am Rhein (DE)

(72) Inventors: William J. KIRK, Charlotte, NC (US); Arlis A. KADRMAS, Charlotte, NC (US); James T. ANDREWS, Charlotte, NC (US); Kostas S. AVRAMIDIS, Charlotte, NC (US); Kimberly L. WALDEN, Charlotte, NC (US)

(21) Appl. No.: 17/922,792

(22) PCT Filed: May 4, 2020
(86) PCT No.: PCT/US2020/031300

§ 371 Date: Nov. 2, 2022

(51) Int. Cl. C08L 95/00; C08G 18/64; C08G 18/76; C08G 18/12; C08G 18/69; C08G 18/48

(52) U.S. Cl. CPC C08L 95/005; C08G 18/6476; C08G 18/7664; C08G 18/12; C08G 18/69; C08G 18/48; C08L 2555/84

(57) ABSTRACT

Asphalt emulsions comprising asphalt present in an amount of 50% by weight or greater, based on the weight of the asphalt emulsion, an isocyanate present in an amount of 0.05% by weight or greater, based on the weight of the asphalt emulsion, and water. The isocyanate is derived from an aromatic, a cycloaliphatic, or an aliphatic isocyanate, or a mixture thereof. Preferably, the isocyanate includes methylene diphenyl diisocyanate. The asphalt emulsion can comprise one or more polyols. Methods of making the asphalt emulsions are also described.

### FIELD OF THE DISCLOSURE

The present disclosure relates to asphalt compositions, particularly to asphalt emulsions modified with an isocyanate.

### BACKGROUND

The National Asphalt Pavement Association reports that of the 2.6 million miles of paved roads in the United States, over 94 percent are paved with asphalt. Asphalt road surfaces typically consist of asphalt and aggregate. Oxidation of asphalt during its service time, climate conditions, and use of road surfaces, particularly by heavy loads, result in deterioration of the road surfaces over time. For example, repeated contraction of the road surface during the cold winter nights due to temperature changes results in formation of cracks in pavement, known as cold fractures. The asphalt becomes too soft during the hot summer days, resulting in a permanent deformation of the road surface under repeated heavy loads, termed “rutting.” In addition, as a result of continuous mechanical stress, road surfaces become fatigued, resulting in formation of alligator skin-like cracks, known as fatigue fracture.

There is a need for durable, high quality asphalt compositions. These asphalt compositions would be of particular value for surface treating exterior surfaces. The compositions and methods described herein address these and other needs.

### SUMMARY OF THE DISCLOSURE

Asphalt emulsions comprising isocyanate are disclosed herein. The asphalt emulsions can include asphalt present in an amount of 50% by weight or greater, based on the weight of the asphalt emulsion, an isocyanate present in an amount of 0.05% by weight or greater, based on the weight of the asphalt emulsion, and water. In certain embodiments, the asphalt can be present in an amount of from 50% to 99% by weight, preferably from 50% to 80% by weight, more preferably from 50% to 75% by weight, based on the weight of the asphalt emulsion. The asphalt emulsions can be a cationic, an anionic, or a non-ionic asphalt emulsion.

The isocyanate used in the asphalt emulsions can be an oligomer, a polymer, or a blend thereof. Preferably, the asphalt emulsions include a polymeric isocyanate. The isocyanate can be derived from an aromatic, a cycloaliphatic, or an aliphatic isocyanate, or a mixture thereof. The functionality of the isocyanate can be 1.5 or greater, from 1.5 to 4, or from 2 to 3. Preferably, the asphalt emulsions include an aromatic diisocyanate. The isocyanate can have a molecular weight of from 100 Da to 250,000 Da, from 100 Da to 100,000 Da, from 100 Da to 50,000 Da, or from 300 Da to 25,000 Da. Suitable examples of isocyanate that can be used in the asphalt emulsions include isocyanates, preferably polymeric isocyanates, derived from methylene diphenyl diisocyanate, toluene diisocyanate, phenylene diisocyanate, tetramethylene diisocyanate, hexamethylene diisocyanate, dicyclohexylmethane diisocyanate, isophorone diisocyanate, triphenylmethane triisocyanate, naphthalene 1,5-diisocyanate, naphthalene 1,4-diisocyanate, xylylene diisocyanate, tetraalkyl-diphenylmethane diisocyanates, 4,4′-diphenyl-dimethylmethane diisocyanate, dibenzyl diisocyanate, benzene triisocyanate, 4,4′-dicyclohexylmethane diisocyanate, 1-isocyanatomethyl-3-isocyanato-1,5,5-trimethyl-cyclohexane (isophorone diisocyanate), cyclohexane 1,4-diisocyanate, hydrogenated xylylene diisocyanate, 1-methyl-2,4-diisocyanato-cyclohexane, m- or p-tetramethylxylylene diisocyanate, tetramethoxybutane 1,4-diisocyanate, butane 1,4-diisocyanate, hexane 1,6-diisocyanate, 1,6-diisocyanato-2,2,4-trimethylhexane, 1,6-diisocyanato-2,4,4-trimethylhexane, lysine diisocyanate and 1,12-dodecane diisocyanate, or mixtures thereof. The isocyanate can be present in an amount from 0.05% to 45%, from 0.5% to 20%, from 0.5% to 10%, or from 0.5% to 5% by weight, based on the weight of the asphalt emulsion.

The isocyanate may react with asphalt in the asphalt emulsion to form a polymer network. For example, the isocyanate may react with functional groups such as amines and/or hydroxyl functional groups in the asphalt to form a polymer network.

In certain embodiments, the asphalt emulsions can include an unmodified asphalt (i.e., an asphalt that has not been modified by a (co)polymer in addition to the isocyanate). In other embodiments, the asphalt emulsions can be modified with a copolymer derived from one or more ethylenically unsaturated monomers selected from the group consisting of styrene, butadiene, meth(acrylate) monomers, vinyl acetate, vinyl ester monomers, and combinations thereof. In some examples, the copolymer includes a styrene-butadiene copolymer, polychloroprene, a styrene-butadiene-styrene copolymer, an ethylene vinyl acetate copolymer, or a combination thereof. In specific examples, the copolymer can include a styrene-butadiene copolymer and/or a styrene-butadiene-styrene copolymer, wherein the styrene and butadiene are in a weight ratio of styrene to butadiene of from 20:80 to 80:20. The copolymer can be further derived from one or more carboxylic acid monomers. For example, the copolymer can comprise from 0.5% to 10% or from 0.5% to 5% by weight carboxylic acid monomers. Suitable examples of the carboxylic acid monomers include itaconic acid, fumaric acid, acrylic acid, methacrylic acid, crotonic acid, or combinations thereof. The copolymer can have a glass transition temperature of from −80° C. to 110° C., from −50° C. to 50° C., from −30° C. to 35° C. or from −30° C. to 10° C. The amount of copolymer in the asphalt emulsion can range from 0.5% by weight or greater, such as from 0.5% to 25% by weight or from 1% to 10% by weight, based on the weight of the asphalt emulsion.

The asphalt emulsion can comprise one or more polyols. The polyol can be selected from a polyalkylene glycol, preferably polyethylene glycol. In some instances, the isocyanate reacts with the polyol. The polyol can be present in an amount of 0.1% by weight or greater, such as from 0.1% to 5% by weight, based on the weight of the asphalt emulsion.

The asphalt emulsion can comprise an aggregate. The aggregate can be present in an amount of 0.1% by weight or greater or from 0.1% to 90% by weight, based on the weight of the asphalt emulsion.

Unmodified asphalt emulsions comprising a PG grade base asphalt and at least 2% by weight isocyanate can have a % recovery, as measured by the Multiple Stress Creep Recovery test according to AASHTO T-350 or ASTM D7405, of at least 30%, preferably at least 35% at the base asphalt high PG temperature and 100 Pa. In certain embodiments, the unmodified asphalt emulsions can have a % recovery, as measured by the Multiple Stress Creep Recovery test according to AASHTO T-350 or ASTM D7405, of at least 20%, preferably at least 25% at the base asphalt high PG temperature and 3200 Pa. The unmodified asphalt emulsions can have an increased % recovery, as measured by the Multiple Stress Creep Recovery test according to AASHTO T-350 or ASTM D7405, of at least 20 percentage points, compared to an identical asphalt emulsion not including the isocyanate.

Copolymer modified asphalt emulsions comprising a PG grade base asphalt and at least 2% by weight isocyanate can have a % recovery, as measured by the Multiple Stress Creep Recovery test according to AASHTO T-350 or ASTM D7405, of at least 50%, preferably at least 70% at the base asphalt high PG temperature and 100 Pa. In certain embodiments, the copolymer modified asphalt emulsions comprising a PG grade base asphalt and at least 2% by weight isocyanate can have a % recovery, as measured by the Multiple Stress Creep Recovery test according to AASHTO T-350 or ASTM D7405, of at least 40%, preferably at least 55% at the base asphalt high PG temperature and 3200 Pa. The copolymer modified asphalt emulsions can have an increased % recovery, as measured by the Multiple Stress Creep Recovery test according to AASHTO T-350 or ASTM D7405, of at least 20 percentage points, compared to an identical asphalt emulsion not including the isocyanate.

Asphalt emulsions described herein and comprising at least 2% by weight isocyanate can have a fresh SHRP high temperature of 70° C. or greater, preferably 76° C. or greater. The asphalt emulsions when dried, can have an elastic recovery of 60% or greater, as measured by the ASTM D6084 Procedure B testing protocol or AASHTO T-301. The asphalt emulsions can have a softening point that is 5° C. or greater compared to the softening point of an identical asphalt emulsion without the isocyanate. Further, the asphalt emulsions when dried, can exhibit an aggregate loss of less than 10%, as measured by the Sweep test two hours after drying according to ASTM D-7000.

Methods of making the asphalt emulsions are also described. The method can include blending asphalt present in an amount of 50% by weight or greater, based on the weight of the asphalt emulsion, an isocyanate present in an amount of 0.05% by weight or greater, based on the weight of the asphalt emulsion, and water to form the asphalt emulsion. Accordingly, asphalt emulsions prepared by a method comprising blending asphalt present in an amount of 50% by weight or greater, based on the weight of the asphalt emulsion, an isocyanate present in an amount of 0.05% by weight or greater, based on the weight of the asphalt emulsion, and water are also disclosed herein. The method can further include blending a solvent other than water such as a rejuvenating agent, a surfactant, a photoinitiator, a basic salt, an acid, or a combination thereof into the asphalt emulsion. The asphalt emulsion can have a viscosity of from 25 to 2000 cp at 60° C., as measured using a Brookfield viscometer, spindle #3, at 20 rpm, when the emulsion comprises an asphalt solids content of 65% by weight, based on the weight of the emulsion.

The details of one or more embodiments are set forth in the description below. Other features, objects, and advantages will be apparent from the description and from the claims.

### DETAILED DESCRIPTION

As used herein, “(meth)acryl . . . ” includes acryl . . . and methacryl . . . and also includes diacryl . . . , dimethacryl . . . and polyacryl . . . and polymethacryl. . . . For example, the term “(meth)acrylate monomer” includes acrylate and methacrylate monomers, diacrylate and dimethacrylate monomers, and other polyacrylate and polymethacrylate monomers.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a,” “an,” and “the” include plural referents unless the context clearly dictates otherwise. The disclosure of percentage ranges and other ranges herein includes the disclosure of the endpoints of the range and any integers provided in the range.

### Asphalt Emulsions

Disclosed herein are asphalt emulsions comprising isocyanate. It has been shown that the presence of the isocyanate in the asphalt emulsions enhances the performance properties of the asphalt emulsions compared to an identical asphalt emulsion without the isocyanate. Without wishing to be bound by theory, it is believed that the isocyanate reacts with the asphalt constituents such as hydroxyl, carboxyl, and amine functionalities among others, to form a covalently-linked polymer network in the asphalt that results in enhanced performance, especially at high temperatures such as 50° C. or above. Isocyanate groups are generally very reactive and can participate in a number of reactions with active hydrogen-atom containing chemical groups. In asphalt emulsions, for example, the isocyanate groups may react with water to form an unstable intermediate, carbamic acid, which decomposes to carbon dioxide and amine. The amine, in turn, may react with additional isocyanates to form urea and polyureas can form when a diisocyanate reacts with two or more amine groups. Accordingly, asphalt emulsions disclosed herein can be free of an isocyanate, as the isocyanate can react with water present in the asphalt emulsions. In other words, the isocyanate can become fully reacted in the asphalt emulsion. Accordingly, compositions comprising an asphalt emulsion prepared by blending asphalt, an isocyanate, and water are disclosed herein. Particularly, asphalt emulsions comprising a product derived from reaction of isocyanate with one or more components in the asphalt emulsion are disclosed herein.

Further, the reaction of isocyanate with a hydroxyl group can produce a urethane, and if the reactants are at least difunctional, polyurethanes can be produced. Accordingly, the presence of a hydroxyl-containing group such as a polyalkylene glycol can provide a reactive prepolymer in the asphalt emulsions which when reacted, may further improve the performance of the asphalt emulsions. This disclosure therefore contemplates the use of urethanes, preferably polyurethanes to modify asphalt emulsions.

### Isocyanate

The asphalt emulsions described herein includes an isocyanate. Isocyanates suitable for use in the asphalt emulsions can include one or more monomeric, oligomeric, or polymeric isocyanates. In some embodiments, the isocyanate is a mono- or poly-isocyanate. The average functionality of isocyanates useful with the asphalt emulsions described herein can be from 1.5 to 5. Further, examples of useful isocyanates include isocyanates with an average functionality of from 2 to 4.5, from 2.2 to 4, from 2.4 to 3.7, or from 2.6 to 3.4. The —NCO functionality on the isocyanate (in the form of monomeric, polymeric, and/or prepolymeric) is what will react with, for example, —OH and/or —NH pendant groups located on the asphalt or additional components including reactive groups such as —OH or —NH groups.

As described herein, the isocyanate can be derived from one or more of an aromatic, an aliphatic, or a cycloaliphatic diisocyanate having molecular weights up to 250,000 Da. For example, the isocyanate can have an average molecular weight of 100 Da or greater (e.g., 200 Da or greater, 250 Da or greater, 300 Da or greater, 350 Da or greater, 400 Da or greater, 450 Da or greater, 500 Da or greater, 550 Da or greater, 600 Da or greater, 650 Da or greater, 700 Da or greater, 750 Da or greater, 1,000 Da or greater, 1,500 Da or greater, 2,000 Da or greater, 2,500 Da or greater, 3,000 Da or greater, 4,000 Da or greater, 5,000 Da or greater, 10,000 Da or greater, 20,000 Da or greater, 50,000 Da or greater, 75,000 Da or greater, 100,000 Da or greater, 150,000 Da or greater, 200,000 Da or greater, or 250,000 Da or greater). In some cases, the isocyanate can have an average molecular weight of 250,000 Da or less (e.g., 200,000 Da or less, 150,000 Da or less, 100,000 Da or less, 75,000 Da or less, 50,000 Da or less, 40,000 Da or less, 30,000 Da or less, 20,000 Da or less, 15,000 Da or less, 10,000 Da or less, 9,000 Da or less, 8,000 Da or less, 7,000 Da or less, 6,000 Da or less, 5,000 Da or less, 4,500 Da or less, 4,000 Da or less, 3,500 Da or less, 3,000 Da or less, 2,500 Da or less, 2,000 Da or less, 1,500 Da or less, 1,250 Da or less, 1,000 Da or less, 900 Da or less, 800 Da or less, 750 Da or less, 700 Da or less, 650 Da or less, 600 Da or less, 550 Da or less, 500 Da or less, 450 Da or less, 400 Da or less, 350 Da or less, or 300 Da or less). In some cases, the isocyanate have an average molecular weight of from 100 Da to 250,000 Da, from 100 Da to 100,000 Da, from 100 Da to 50,000 Da, from 100 Da to 25,000 Da, from 200 Da to 10,000 Da, from 200 Da to 5,000 Da, from 250 Da to 1,500 Da, 250 Da to 750 Da, from 250 Da to 600 Da, or from 250 Da to 500 Da.

Suitable examples of aromatic isocyanates for use in the asphalt emulsions include isomers of toluene diisocyanate, naphthalene 1,5-diisocyanate, naphthalene 1,4-diisocyanate, diphenylmethane 4,4′-diisocyanate, diphenylmethane 2,4′-diisocyanate and mixtures of 4,4′-diphenylmethane diisocyanate with the 2,4′ isomer, hydrogenated xylylene diisocyanate, 4,4′-diphenyl-dimethylmethane diisocyanate, di- and tetraalkyl-diphenylmethane diisocyanates, 4,4′-dibenzyl diisocyanate, 1,3-phenylene diisocyanate, triphenylmethane triisocyanate, 1,4-phenylene diisocyanate, or combinations thereof. Suitable examples of cycloaliphatic diisocyanates include 4,4′-dicyclohexylmethane diisocyanate, 1-isocyanatomethyl-1,3-isocyanato-1,5,5-trimethyl-cyclohexane (isophorone diisocyanate), cyclohexane 1,4-diisocyanate, isophorone diisocyanate, xylylene diisocyanate, 1-methyl-2,4-diisocyanato-cyclohexane, m- or p-tetramethylxylene diisocyanate, dimer fatty acid diisocyanate, or combinations thereof. Suitable examples of aliphatic diisocyanates are tetramethylene diisocyanate, hexamethylene diisocyanate, tetramethoxybutane 1,4-diisocyanate, butane 1,4-diisocyanate, hexane 1,6-diisocyanate, 1,6-diisocyanato-2,2,4-trimethylhexane, 1,6-diisocyanato-2,4,4-trimethylhexane, lysine diisocyanate, 1,12-dodecane diisocyanate, or combinations thereof.

The particular isocyanate used in the asphalt emulsions can be selected based on the desired properties of the emulsions, such as the viscosity, elasticity, penetration, softening point, and the like of the mixture. An example of a useful diisocyanate is methylene diphenyl diisocyanate (MDI) and/or toluene diisocyanate (TDI). Suitable MDI's include MDI monomers, MDI oligomers, MDI polymers, and mixtures thereof. Further examples of useful isocyanates include those having NCO (i.e., the reactive group of an isocyanate) contents ranging from about 25% to about 95% by weight. Examples of useful isocyanates are found, for example, in Polyurethane Handbook: Chemistry, Raw Materials, Processing Application, Properties, 2^{nd} Edition, Ed: Gunter Oertel; Hanser/Gardner Publications, Inc., Cincinnati, Ohio, which is herein incorporated by reference. Isocyanates are commercially available, for example, from BASF Corporation, Bayer Corporation (Pittsburgh, Pa.), The Dow Chemical Company, Huntsman Polyurethanes, and Ecopur Industries.

In some examples, the isocyanate used in the asphalt emulsions can include MDI and/or TDI constituting at least about 40% by weight, at least about 60% by weight, at least about 75% by weight, at least about 80% by weight, at least about 90% by weight, or at least about 95% by weight, of the total isocyanate present.

As described herein, the isocyanate can react to form urea, polyurea, urethane, and/or polyurethane with various functional groups in the asphalt emulsions. Accordingly, asphalt emulsions comprising urea, polyurea, urethane, and/or polyurethane are also described herein. The term “react” as used herein refers to the interaction between two or more individual components (e.g. molecules) present in the asphalt emulsion by covalent bonds. The specific reaction will depend on the specific functional groups, for example, an isocyanate and a hydroxyl group or an isocyanate and an amine. In some embodiments, a substantial amount of the isocyanate reacts with functional groups present in the asphalt emulsions through covalent interactions. For example, greater than 50% by weight, 60% by weight or more, 70% by weight or more, 75% by weight or more, 80% by weight or more, 85% by weight or more, 90% by weight or more, 95% by weight or more, 98% by weight or more, or 100% by weight of the isocyanate can react with functional groups present in the asphalt emulsions.

The isocyanate can be present in an amount of 0.05% or greater by weight, based on the total weight of the asphalt emulsion. For example, the isocyanate can be present in an amount of 0.1% or greater, 0.3% or greater, 0.5% or greater, 0.8% or greater, 1% or greater, 1.5% or greater, 2% or greater, 2.5% or greater, 3% or greater, 3.5% or greater, 4% or greater, 4.5% or greater, 5% or greater, 5.5% or greater, 6% or greater, 6.5% or greater, 7% or greater, 7.5% or greater, 8% or greater, 8.5% or greater, 9% or greater, 10% or greater, 12% or greater, 15% or greater, 20% or greater, 25% or greater, 30% or greater, 35% or greater, 40% or greater, or 45% or greater by weight, based on the total weight of the asphalt emulsion. In some embodiments, the isocyanate can be present in an amount of 50% or less, 45% or less, 40% or less, 35% or less, 30% or less, 25% or less, 20% or less, 15% or less, 12% or less, 11% or less, 10% or less, 9% or less, 8% or less, 7% or less, 5% or less, 4% or less, 3% or less, 2.5% or less, 2% or less, 1.5% or less, or 1% or less by weight, based on the total weight of the asphalt emulsion. In some embodiments, the isocyanate can be present in an amount of from 0.05% to 50%, from 0.05% to 45%, from 0.5% to 45%, from 0.05% to 25%, from 0.05% to 20%, from 0.05% to 15%, from 0.05% to 10%, from 0.1% to 10%, from 0.1% to 8%, from 0.1% to 5%, from 0.5% to 10%, from 0.5% to 8%, from 0.5% to 5%, from 1% to 15%, from 1% to 10%, or from 2% to 10% by weight, based on the total weight of the asphalt emulsion.

### Asphalts

In addition to the isocyanate, the asphalt emulsions also include asphalt and water. The term “asphalt” as used herein, includes the alternative term “bitumen.” Thus, the asphalt emulsions can be termed bitumen emulsions. All types of asphalt, both naturally occurring and synthetically manufactured, are suitable for use in the asphalt emulsions disclosed herein. Naturally occurring asphalt is inclusive of native rock asphalt, lake asphalt, and such the like. Synthetically manufactured asphalt is generally a by-product of petroleum refining operations and includes air-blown asphalt, blended asphalt, cracked or residual asphalt, petroleum asphalt, propane asphalt, straight-run asphalt, thermal asphalt, and the like. A portion of the “reactive” component of the asphalt comes from asphaltene and polar resins. Thus, the more asphaltene-rich colloidal microstructures in the asphalt, the larger degree of active modification is obtained. Asphaltene can be present in an amount of 10% by weight or greater, such as from 10% to 55%, from 10% to 50%, from 15% to 45%, or from 20% to 45%, by weight of the asphalt. Asphalt PG 64-22 grade has about 15% asphaltene content. The more asphaltene present, the more —OH and —NH reactive sites exist, and the more reactive sites are available for reaction with an —NCO group.

In some embodiments, the asphalt used in the emulsions disclosed herein has a high temperature true performance grade of 45° C. or greater, such as 48° C. or greater, 50° C. or greater, 52° C. or greater, 54° C. or greater, 55° C. or greater, 56° C. or greater, or 58° C. or greater, as determined by AASHTO test TP5. In some embodiments, the asphalt used in the emulsions disclosed herein has a low temperature true performance grade of −10° C. or less, −15° C. or less, −20° C. or less, −25° C. or less, −28° C. or less, such as −30° C. or less, −32° C. or less, −34° C. or less, −35° C. or less, −40° C. or less, as determined by AASHTO test TP5. The asphalt emulsions disclosed herein are applicable to various types of asphalts, including asphalts softer than PG 64-22. Specifically, the asphalt emulsions disclosed herein can be used with asphalts such as PG 58-28 asphalts or softer. In some embodiments, a blend of asphalt can be used in the asphalt compositions.

The asphalt emulsions can include 50% or greater by weight of asphalt, based on the weight of the asphalt emulsion. In some embodiments, the asphalt emulsions can include 55% or greater, 60% or greater, 65% or greater, 70% or greater, 75% or greater, 80% or greater, 85% or greater, 90% or greater, or 95% or greater by weight of asphalt, based on the weight of the asphalt emulsion. In some embodiments, the asphalt emulsions can include 99% or less, 95% or less, 90% or less, 85% or less, 80% or less, 75% or less, 70% or less, 67.5% or less, 65% or less, 62.5% or less, or 60% or less by weight of asphalt, based on the weight of the asphalt emulsion. In some embodiments, the asphalt emulsions can include 50% to 95%, 50% to 92%, 50% to 90%, 50% to 85%, 50% to 80%, 50% to 75%, 60% to 95%, 60% to 90%, or 60% to 80% by weight of asphalt, based on the weight of the asphalt emulsion.

### Surfactants

The asphalt emulsion can include one or more surfactants (emulsifiers) such as nonionic surfactants, anionic surfactants, cationic surfactants, amphoteric surfactants, or a mixture thereof. In some embodiments, the asphalt emulsion can include an amine-derived surfactant. Suitable surfactants include polyamines, fatty amines, fatty amido-amines, ethoxylated amines, diamines, imidazolines, quaternary ammonium salts, and mixtures thereof. Examples of commercially available surfactants that can be used in the asphalt emulsions include those available from Akzo Nobel under the REDICOTE® trademark (such as REDICOTE® 4819, REDICOTE® E-64R, REDICOTE® E-5, REDICOTE® E-9, REDICOTE® E9A, REDICOTE® E-11, REDICOTE® E-16, REDICOTE® E-44, REDICOTE® E-62, REDICOTE® E-120, REDICOTE® E-250, REDICOTE® E-2199, REDICOTE® E-4868, REDICOTE® E-7000, REDICOTE® C-346, REDICOTE® C-404, REDICOTE® C-450, and REDICOTE® C-471), surfactants available from Ingevity under the INDULIN® and AROSURF® trademarks (such as INDULIN® 201, INDULIN® 202, INDULIN® 206, INDULIN® 814, INDULIN® AA-54, INDULIN® AA-57, INDULIN® AA-78, INDULIN® AA-86, INDULIN® AA-89, INDULIN® AMS, INDULIN® DF-30, INDULIN® DF-40, INDULIN® DF-42, INDULIN® DF-60, INDULIN® DF-80, INDULIN® EX, INDULIN® FRC, INDULIN® HFE, INDULIN® IFE, INDULIN® MQK, INDULIN® MQK-1M, INDULIN® MQ3, INDULIN® QTS, INDULIN® R-20, INDULIN® FST (also known as PC-1542), INDULIN® SA-L, INDULIN® SBT, INDULIN® W-1, and INDULIN® W-5), ASFIER® N480 available from Kao Specialties Americas, CYPRO™ 514 available from Cytec Industries, polyethyleneimines such as those available from BASF under the POLYMIN® trademark (such as POLYMIN® SK, POLYMIN® SKA, POLYMIN® 131, POLYMIN® 151, POLYMIN® 8209, POLYMIN® P, and POLYMIN® PL), polyvinylamines such as those available from BASF under the CATIOFAST® trademark (such as CATIOFAST® CS, CATIOFAST® FP, CATIOFAST® GM, and CATIOFAST® PL), and tall oil fatty acids. The surfactant can be in an amount of from 0.01% to 5%, 0.05% to 4%, 0.1% to 5%, 0.2% to 4%, or 0.3% to 3%, by weight, based on the weight of the asphalt emulsion.

In some embodiments, the asphalt emulsion can be an anionic asphalt emulsion. The anionic asphalt emulsion generally has a high pH, such as a pH greater than 7. For example, the asphalt emulsion can have a pH of 7.5 or greater, 8 or greater, 8.5 or greater, 9 or greater, or 9.5 or greater. In some examples, the asphalt emulsion can have a pH of 12 or less, 11.5 or less, 11 or less, 10.5 or less, 10 or less, 9.5 or less, 9 or less, 8.5 or less, or 8 or less. In some embodiments, the asphalt emulsion can have a pH of from greater than 7 to 12, from 7.5 to 11, or from 8 to 11.

In some embodiments, the asphalt emulsion can be a cationic asphalt emulsion. The cationic asphalt emulsion generally has a low pH, such as a pH of less than 7. For example, the asphalt emulsion can have a pH of 6.5 or less, 6 or less, 5.5 or less, 5 or less 4.5 or less 4 or less, 3.5 or less, 3 or less, or 2.5 or less. In some examples, the asphalt emulsion can have a pH of 1.5 or greater, 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the asphalt emulsion can have a pH of from 1.5 to 7, from 2 to 6.5, from 1.5 to 6, from 2 to 6, from 3 to 7, from 3 to 6.5, from 3 to 6, from 4 to 7, from 4 to 6.5, or from 4 to 6.

In some embodiments, the asphalt emulsion can be a non-ionic asphalt emulsion. The non-ionic asphalt emulsion generally has a pH from about 6 to about 8, such as pH 6, pH 6.5, pH 7, pH 7.5, or pH 8.

### Polymer Modification

Polymeric additives can be included in the asphalt emulsions (generally referred to as “polymer modified asphalt” emulsions) for providing certain enhanced properties. In some embodiments, the polymer can be derived from ethylenically unsaturated monomers. For example, the polymer can be a pure acrylic polymer (i.e., a polymer derived exclusively from (meth)acrylate and/or (meth)acrylic acid monomers), a styrene-butadiene copolymer (i.e., a polymer derived from butadiene and styrene monomers), a styrene-butadiene-styrene block copolymer, a vinyl aromatic-acrylic copolymer (i.e., a polymer derived from vinyl aromatic monomers such as styrene and one or more (meth)acrylate and/or (meth)acrylic acid monomers), a vinyl-acrylic copolymer (i.e., a polymer derived from one or more vinyl ester monomers and one or more (meth)acrylate and/or (meth)acrylic acid monomers), a vinyl chloride polymer (i.e., a polymer derived from one or more vinyl chloride monomers), a vinyl alkanoate polymer (i.e., a polymer derived from one or more vinyl alkanoate monomers, such as polyvinyl acetate or a copolymer derived from ethylene and vinyl acetate monomers), or a combination thereof. The term “(meth)acryl . . . ,” as used herein, includes “acryl . . . ,” “methacryl . . . ,” or mixtures thereof. The polymer can be a random copolymer or a block copolymer. In some embodiments, the polymer can include a styrene-butadiene copolymer, polychloroprene, a styrene-butadiene-styrene block copolymer, an ethylene vinyl acetate copolymer, a styrene acrylic copolymer, an acrylic polymer, a vinyl acrylic copolymer, or a combination thereof.

Suitable unsaturated monomers for use in forming the polymer are generally ethylenically unsaturated monomers and include vinylaromatic compounds (e.g. styrene, α-methylstyrene, o-chlorostyrene, and vinyltoluenes); 1,2-butadiene (i.e. butadiene); conjugated dienes (e.g. 1,3-butadiene and isoprene); α,β-monoethylenically unsaturated mono- and dicarboxylic acids or anhydrides thereof (e.g. acrylic acid, methacrylic acid, crotonic acid, dimethacrylic acid, ethylacrylic acid, allylacetic acid, vinylacetic acid maleic acid, fumaric acid, itaconic acid, mesaconic acid, methylenemalonic acid, citraconic acid, maleic anhydride, itaconic anhydride, and methylmalonic anhydride); esters of α,β-monoethylenically unsaturated mono- and dicarboxylic acids having 3 to 6 carbon atoms with alkanols having 1 to 12 carbon atoms (e.g. esters of acrylic acid, methacrylic acid, maleic acid, fumaric acid, or itaconic acid, with C₁-C₁₂, C₁-C₈, or C₁-C₄ alkanols such as ethyl, n-butyl, isobutyl and 2-ethylhexyl acrylates and methacrylates, dimethyl maleate and n-butyl maleate); acrylamides and alkyl-substituted acrylamides (e.g. (meth)acrylamide, N-tert-butylacrylamide, and N-methyl(meth)acrylamide); (meth)acrylonitrile; vinyl and vinylidene halides (e.g. vinyl chloride and vinylidene chloride); vinyl esters of C₁-C₁₈ mono- or dicarboxylic acids (e.g. vinyl acetate, vinyl propionate, vinyl n-butyrate, vinyl laurate and vinyl stearate); C₁-C₄ hydroxyalkyl esters of C₃-C₆ mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mol of ethylene oxide, propylene oxide, butylene oxide or mixtures thereof (e.g. hydroxyethyl (meth)acrylate, hydroxypropyl (meth)acrylate, and methylpolyglycol acrylate); and monomers containing glycidyl groups (e.g. glycidyl methacrylate).

The polymer can include on more additional monomers. The additional monomers can include, for example, other vinyl aromatic compounds (e.g., α-methylstyrene, o-chlorostyrene, and vinyltoluene); isoprene; anhydrides of α,β-monoethylenically unsaturated monocarboxylic and dicarboxylic acids (e.g., maleic anhydride, itaconic anhydride, and methylmalonic anhydride); other alkyl-substituted acrylamides (e.g., N-tent-butylacrylamide and N-methyl(meth)acrylamide); vinyl and vinylidene halides (e.g., vinyl chloride and vinylidene chloride); vinyl esters of C₁-C₁₈ monocarboxylic or dicarboxylic acids (e.g., vinyl acetate, vinyl propionate, vinyl N-butyrate, vinyl laurate, and vinyl stearate); C₁-C₄ hydroxyalkyl esters of C₃-C₆ monocarboxylic or dicarboxylic acids, for example of acrylic acid, methacrylic acid, or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mol of ethylene oxide, propylene oxide, butylene oxide or mixtures thereof (e.g., hydroxyethyl (meth)acrylate, hydroxypropyl (meth)acrylate, and methylpolyglycol acrylate); monomers containing glycidyl groups (e.g., glycidyl methacrylate); linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-N-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate, and sulfopropyl methacrylate); vinylphosphonic acid, dimethyl vinylphosphonate, and other phosphorus monomers (e.g., phosphoethyl (meth)acrylate); alkylaminoalkyl (meth)acrylates or alkylaminoalkyl(meth)acrylamides or quatemization products thereof (e.g., 2-(N,N-dimethylamino)ethyl (meth)acrylate, 3⁻(N,N-dimethylamino)propyl (meth)acrylate, 2-(N,N,N-trimethylammonium)ethyl (meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C₁-C₃₀ monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine); monomers containing 1,3-diketo groups (e.g., acetoacetoxyethyl (meth)acrylate or diacetone acrylamide); monomers containing urea groups (e.g., ureidoethyl (meth)acrylate, acrylamidoglycolic acid, and methacrylamidoglycolate methyl ether); monoalkyl itaconates; monoalkyl maleates; hydrophobic branched ester monomers; monomers containing silyl groups (e.g., trimethoxysilylpropyl methacrylate), vinyl esters of branched mono-carboxylic acids having a total of 8 to 12 carbon atoms in the acid residue moiety and 10 to 14 total carbon atoms such as, vinyl 2-ethylhexanoate, vinyl neo-nonanoate, vinyl neo-decanoate, vinyl neo-undecanoate, vinyl neo-dodecanoate and mixtures thereof, and copolymerizable surfactant monomers (e.g., those sold under the trademark ADEKA REASOAP). In some embodiments, the one or more additional monomers include (meth)acrylonitrile, (meth)acrylamide, or a mixture thereof. In some embodiments, the polymer can include the one or more additional monomers in an amount of greater than 0% to 10% by weight, based on the weight of the polymer. For example, the polymer can include the one or more additional monomers in an amount of 0.5% to 10%, 0.5% to 5%, 0.5% to 4%, 0.5% to 3%, 0.5% to 2%, or 0.5% to 1% by weight, based on the weight of the polymer.

The polymer can include one or more crosslinking monomers. Exemplary crosslinking monomers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glycidyl (meth)acrylate; glyoxal based crosslinkers; monomers containing two vinyl radicals; monomers containing two vinylidene radicals; and monomers containing two alkenyl radicals. Other crosslinking monomers include, for instance, diesters of dihydric alcohols with α,β-monoethylenically unsaturated monocarboxylic acids, of which in turn acrylic acid and methacrylic acid can be employed. Examples of such monomers containing two non-conjugated ethylenically unsaturated double bonds can include alkylene glycol diacrylates and dimethacrylates, such as ethylene glycol diacrylate, 1,3-butylene glycol diacrylate, 1,4-butylene glycol diacrylate and propylene glycol diacrylate, divinylbenzene, vinyl methacrylate, vinyl acrylate, allyl methacrylate, allyl acrylate, diallyl maleate, diallyl fumarate, methylenebisacrylamide, and mixtures thereof. In some embodiments, the polymer can include from 0.01% to 5% by weight of the polymer, of the crosslinking agent.

In some embodiments, the polymer in the asphalt emulsions can include styrene, butadiene, and optionally, one or more additional monomers. The styrene can be in an amount of 2% or greater by weight, based on the weight of the polymer. For example, the styrene can be in an amount of 5% or greater, 10% or greater, 20% or greater, 30% or greater, 40% or greater, 50% or greater, 60% or greater, or 70% or greater, by weight, based on the weight of the polymer. In some embodiments, the styrene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer. The butadiene can be in an amount of 2% by weight of the polymer. For example, the butadiene can be in an amount of 5% or greater, 10% or greater, 20% or greater, 30% or greater, 40% or greater, 50% or greater, 60% or greater, or 70% or greater by weight, based on the weight of the polymer. In some embodiments, the butadiene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer. In some embodiments, the weight ratio of styrene to butadiene monomers in the polymer can be from 1:99 to 99:1, from 20:80 to 80:20, from 30:70 to 70:30, or from 40:60 to 60:40. For example, the weight ratio of styrene to butadiene can be 25:75 or greater, 30:70 or greater, 35:65 or greater, or 40:60 or greater.

The styrene butadiene copolymer can include a carboxylic acid monomer. In some embodiments, the polymer can include a carboxylated styrene-butadiene copolymer derived from styrene, butadiene, and a carboxylic acid monomer. In some embodiments, the polymer can be derived from 0.5%-10%, 1-9%, or 2-8% by weight of a carboxylic acid monomer. Suitable carboxylic acid monomers include (meth)acrylic acid, itaconic acid, fumaric acid, or mixtures thereof. In some embodiments, the polymer can include a non-carboxylated styrene-butadiene copolymer (i.e., not derived from a carboxylic acid monomer). In some embodiments, the polymer includes one or more of the other monomers provided above.

The polymer can have a glass-transition temperature (T_{g}), as measured by differential scanning calorimetry (DSC) using the mid-point temperature as described, for example, in ASTM 3418/82, of from −80° C. to 110° C. In some embodiments, the polymer has a measured T_{g} of −80° C. or greater (for example, −70° C. or greater, −60° C. or greater, −50° C. or greater, −40° C. or greater, −30° C. or greater, −20° C. or greater, −10° C. or greater, 0° C. or greater, 10° C. or greater, 20° C. or greater, 30° C. or greater, 40° C. or greater, 50° C. or greater, 60° C. or greater, 70° C. or greater, 80° C. or greater, 90° C. or greater, 100° C. or greater, up to 110° C.). In some cases, the polymer has a measured T_{g} of 110° C. or less (e.g., less than 110° C., 100° C. or less, 90° C. or less, 80° C. or less, 70° C. or less, 60° C. or less, 50° C. or less, 40° C. or less, 30° C. or less, 25° C. or less, 20° C. or less, 10° C. or less, 0° C. or less, −10° C. or less, −20° C. or less, −25° C. or less, −30° C. or less, −35° C. or less, −40° C. or less, −45° C. or less, or −50° C. or less). In certain embodiments, the polymer has a measured T_{g} of from −80° C. to 110° C., from −80° C. to 80° C., from −80° C. to 40° C., from −50° C. to 110° C., from −50° C. to 80° C., from −50° C. to 50° C., from −50° C. to 25° C., from −40° C. to 80° C., −40° C. to 50° C., −40° C. to 0° C., from −80° C. to 0° C., from −80° C. to −10° C., from −60° C. to 0° C., or from −60° C. to less than 0° C.

In some embodiments, the polymer in the asphalt composition can be a styrene-butadiene copolymer. Suitable commercially available styrene-butadiene copolymers can include BUTONAL® NX1118, BUTONAL® NX 1138, BUTONAL® NX 4190, and BUTONAL® NS 198, commercially available from BASF Corporation.

The polymer in the asphalt emulsions can be in an amount of 0.25% or greater by weight, based on the weight of the asphalt emulsions. In some embodiments, the asphalt emulsions can include the polymer in an amount of 0.25% or greater, 0.5% or greater, 0.75% or greater, 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, or 9% or greater by weight, based on the weight of the asphalt emulsions. In some embodiments, the asphalt emulsions can include the polymer in an amount of 10% or less, 8% or less, 7% or less, 6% or less, 5% or less, 4% or less, 3% or less, 2% or less, or 1% or less by weight, based on the weight of the asphalt emulsions. In some embodiments, the asphalt emulsions can include the polymer in an amount of 0.25% to 10%, 0.5% to 8%, 0.5% to 6%, 0.75% to 5%, or 0.75% to 4% by weight, based on the weight of the asphalt emulsions.

In some embodiments, the polymer can be provided in the form of a latex composition. The latex composition can be an aqueous dispersion including particles of the polymer dispersed in water. In some embodiments, the latex composition can be prepared with a total solids content of from 5% to 90% by weight, for example, 10% to 80% by weight, 20% to 70% by weight, 25% to 65% by weight, 35% to 60% by weight, or 45% to 60% by weight, based on the weight of the latex composition. In some embodiments, the latex composition can have a total solids content of 40% or greater or 50% or greater by weight, based on the weight of the latex composition. In some embodiments, the latex composition can have a total solids content of 90% or less, 80% or less, or 70% or less by weight, based on the weight of the latex composition. The polymer particles in the latex composition can have an average particle size of from 20 nm to 500 nm, such as from 20 nm to 400 nm, from 30 nm to 300 nm, or from 50 nm to 250 nm. The particle size of the polymer particles can be measured using dynamic light scattering measurements, for example using a Nicomp Model 380 available from Particle Sizing Systems, Santa Barbara, Calif.

The latex composition can be cationic, anionic, or non-ionic. In some embodiments, the latex composition can be cationic. For example, the latex composition can include a cationic surfactant such as an amine-containing surfactant at a suitable pH (e.g., below the pKa of the amine group in the cationic surfactant). In some embodiments, the latex composition can be anionic. For example, the latex composition can include a carboxylated polymer, such as a carboxylated styrene butadiene copolymer. In some embodiments, the latex composition (including the cationic, anionic, or non-ionic latex composition) can have a pH of 7 or less. For example, the latex composition can have a pH of 6.5 or less, 6 or less, 5.5 or less, 5 or less, 4.5 or less, 4 or less, or 3.5 or less. In some examples, the latex composition can have a pH of 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the latex composition can have a pH of from 2 to 7, from 2 to 6.5, from 2 to 6, from 3 to 7, from 3 to 6.5, from 3 to 6, from 4 to 7, from 4 to 6.5, or from 4 to 6.

The latex composition can include one or more surfactants (emulsifiers) such as nonionic surfactants, anionic surfactants, cationic surfactants, amphoteric surfactants, or a mixture thereof. In some embodiments, the latex compositions can include a surfactant as described herein.

The latex in the asphalt emulsions can be in an amount of 0.25% or greater by weight, based on the weight of the asphalt emulsions. In some embodiments, the asphalt emulsions can include the latex in an amount of 0.25% or greater, 0.5% or greater, 0.75% or greater, 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, 9% or greater, 10% or greater, 12% or greater, 14% or greater, 15% or greater, 16% or greater, 18% or greater, or 20% or greater by weight, based on the weight of the asphalt emulsions. In some embodiments, the asphalt emulsions can include the latex in an amount of 20% or less, 15% or less, 12% or less, 10% or less, 8% or less, 7% or less, 6% or less, 5% or less, 4% or less, 3% or less, 2% or less, or 1% or less by weight, based on the weight of the asphalt emulsions. In some embodiments, the asphalt emulsions can include the latex in an amount of 0.25% to 20%, 0.5% to 15%, 0.25% to 10%, 0.5% to 8%, 0.5% to 6%, 0.75% to 5%, or 0.75% to 4% by weight, based on the weight of the asphalt emulsions.

### Polyol

The asphalt emulsion can include one or more polyols. The polyol can react with the isocyanate prior to, during, or after blending the isocyanate in the asphalt. For example, the polyol can react with the isocyanate to produce a polyurethane prepolymer that can be later reacted with the asphalt. In other embodiments, the polyol can react completely or substantially completely with the remaining available isocyanate groups present in the asphalt emulsions. The polyol can have two or more hydroxyl groups. For example, the polyol can include di- and/or trifunctional compounds with two or more hydroxyl groups per molecule. Suitable polyols include polyalkylene glycols such as polyethylene glycol, polypropylene glycol, polybutylene glycol, or polytetramethylene glycol; polyester-polyols; or hydroxyl-functional polybutadiene polyols.

The polyol can have a molecular weight of 400 Da or greater, such as from 400 Da to 20,000 Da, from 400 Da to 10,000 Da, or from 400 Da to 5,000 Da. In certain embodiments, the polyol can include a low molecular weight polyol such as alkylene diols (e.g., butanediol, hexanediol, octanediol, decanediol, or dodecanediol).

Suitable polyols that can be used include polypropylene glycols (Diol) [e.g., PLURACOL™ by BASF]; propylene oxide adduct of glycerine (Triol) [e.g., PLURACOL™ by BASF], polyether polyols (Diol & Triol) [e.g., VORANOL™ Polyols by Dow, ARCOL™ Polyol by Bayer, ACCLAIM™ Polyol by Bayer, ULTRACEL™ by Bayer]; hydroxyl functional polybutadiene polyols [e.g., POLY BD™ and KRASOL™, from Cray Valley], polycarbonate diols [POLY-CD™ 220 from Monument Chemical], polypropylene oxide-based polyol (Diol) [e.g., MULTRANOL™ by Bayer, etc.]; 1,12-octadecanediol; 1,2,3-propanetriol; 1,2,6-hexanetriol; 1,2-ethanediol; 1,3-butanediol; 1,4-benzenediol; 1,9-nonanediol; 2,2,4,4-tetramethyl-1,3-cyclobutanediol; 2,2,4-trimethyl-1,3-pentanediol; 2,2-bis(hydroxymethyl)-1,3-propanediol; 2,2-diethyl-1,3-propanediol; 2,2-dimethyl-1,3-butanediol; 2,3-butanediol; 2,3-naphthalenediol; 2,4-hexadiyne-1,6-diol; 2,7-dimethyl-3,5-octadiyne-2,7-diol; 2-butyl-2-ethyl-1,3-propanediol; 2-ethyl-2-methyl-1,3-propanediol; 2-methyl-2-propyl-1,3-propanediol; 3-chloro-1,2-propanediol; 3-methyl-1,3-butanediol; 3-methyl-2,4-pentanediol; 9-octadecene-1,12-diol; ACTOL™ 21-56 diol; actol 22-110 diol;

actol 23-95 diol; actol 32-160 triol; actol 33-46 triol; butanediol; butanetriol; butenediol; butynediol; dimethyl octanediol; and dimethylhexanediol. In some cases, the polyol can be a petroleum-based polyol, but it can also be produced using soy, castor, or other so-called “green” sources.

The polyol can be present in an amount of 0.1% by weight or greater, 0.5% or greater, 0.75% or greater, 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, or 9% or greater by weight, based on the weight of the asphalt emulsions. In some embodiments, the asphalt emulsions can include the polyol in an amount of 10% or less, 8% or less, 7% or less, 6% or less, 5% or less, 4% or less, 3% or less, 2% or less, or 1% or less by weight, based on the weight of the asphalt emulsions. In some embodiments, the asphalt emulsions can include the polyol in an amount of 0.1% to 10%, 0.1% to 5%, 0.5% to 8%, 0.5% to 6%, or 0.75% to 4% by weight, based on the weight of the asphalt emulsions

### Other additives

The asphalt emulsions can further include an additive to decrease the drying time of the asphalt emulsions. The additive can include a polyamine such as a polyalkyleneimine. Suitable polyalkyleneimine for use in the asphalt emulsions are described in U.S. Provisional Application No. 62/648,639 to Avramidis et al., U.S. Pat. No. 8,193,144 to Tanner, et al., U.S. Pat. No. 7,268,199 to Andre, et al., U.S. Pat. No. 7,736,525 to Thankachan, et al, U.S. Pat. No. 6,811,601 to Borzyk, et al. and WO 99/67352, all of which are incorporated herein by reference for their teaching of alkoxylated polyalkyleneimines. In particular embodiments, the asphalt emulsions can contain an alkoxylated polyalkyleneimine such as an ethoxylated polyethyleneimine, a propoxylated polyethyleneimine, a butoxylated polyethyleneimine, or a combination thereof. The polyalkyleneimines can be present in the composition at from 0% by weight to 10% by weight, or from 0.1% by weight to 10% by weight, based on the dry weight of the emulsions.

The asphalt emulsions described herein can also contain a base. In some embodiments, the base can be a volatile base. Suitable bases can be selected on the basis of several factors, including their alkalinity and volatility. Exemplary bases include, but are not limited to, ammonia, lower alkylamines such as dimethylamine, triethylamine, and diethylamine, ethanolamine, diethanolamine, triethanolamine, morpholine, aminopropanol, 2-amino-2-methyl-1-propanol, 2-dimethylaminoethanol, and combinations thereof. In some embodiments, the functional groups, such as NH₂ and OH of the base may react with components of the asphalt system, such as with the isocyanate groups. In certain embodiments, the base is ammonia. In some cases, ammonia is the sole base present in the emulsions. Alternatively, ammonia can be incorporated in admixture with other bases, such as alkali metal hydroxides, or combinations thereof.

The asphalt emulsions can also include a photoinitiator. Photoinitiators are compounds that can generally bring about a crosslinking reaction of a polymer by exposure to sunlight. Suitable photoinitiators for use in the asphalt emulsions are described in U.S. Provisional Application No. 62/648,639 to Avramidis et al. and EP-A-209 831. Examples of suitable compounds for use as a photoinitiator are those having a diaryl ketone structure, such as benzophenone, thioxanthone, and derivatives thereof. The photoinitiators can be used in the asphalt emulsions in an amount of from 0.01% to 5% by weight, based on the asphalt emulsions.

The asphalt emulsions can include a basic salt. Suitable basic salts can include the salt of a strong base and a weak acid. In some embodiments, the asphalt emulsions can include a basic salt selected from sodium sulfate, potassium sulfate, magnesium sulfate, aluminum sulfate, iron sulfate, cobalt sulfate, barium sulfate, beryllium sulfate, copper sulfate, zinc sulfate, manganese sulfate, sodium carbonate, sodium bicarbonate, potassium carbonate, potassium bicarbonate, potassium sodium carbonate, sodium bisulfate, ammonium bisulfite, potassium bisulfate, potassium sulfite, sodium sulfite, potassium hydrogen sulfite, ammonium sulfite, disodium hydrogen phosphate, sodium dihydrogen phosphate, dipotassium hydrogen phosphate, and mixtures thereof. In some embodiments, the basic salt can include aluminum sulfate. The basic salt, such as aluminum sulfate can be in an amount of from 0.01% to 5%, 0.05% to 4%, 0.1% to 5%, 0.2% to 4%, or 0.3% to 3%, by weight, based on the weight of the asphalt emulsions. The asphalt emulsions can include the basic salt in an amount such that the pH of the asphalt formulation has a pH of from 1.5 to 10, such as from 1.5 to 6 or from 8 to 10.

The asphalt emulsions further include a solvent such as water to disperse or emulsify the isocyanate/polymer and/or the asphalt. The asphalt emulsions can include water in an amount of 1% to 45%, 1% to 40%, 1% to 35%, 5% to 30%, 5% to 45%, 5% to 40%, 5% to 25%, 10% to 45%, 10% to 40%, or 10% to 25% by weight, based on the weight of the asphalt emulsions. In some instances, the asphalt emulsions can include a second solvent, in addition to water. For example, the asphalt emulsions can include a rejuvenating (or recycling) agent that includes a non-aqueous solvent and optionally water. The rejuvenating agent can include any known rejuvenating agent appropriate for the type of asphalt surface that the asphalt emulsions are applied to. Rejuvenating (recycling) agents are classified into types such as RA-1, RA-5, RA-25, and RA-75 as defined by ASTM D4552. The rejuvenating agent used herein can be a material that resembles the maltene fraction of asphalt such as a RA-1 rejuvenating agent, a RA-5 rejuvenating agent, or mixtures thereof. In some examples, the rejuvenating agent is a RA-1 recycling agent such as those available as RA-1 from vendors such as San Joaquin Refining or Tricor Refining or under the trade name HYDROLENE® (such as HYDROLENE® HT100T) from Sunoco.

The amount of rejuvenating agent can be from 0% to 15% by weight, such as from 2 to 15% or 2 to 8% by weight, or from 3% to 6% by weight (e.g. 5% by weight) of the asphalt emulsion.

The asphalt emulsions can be vulcanized or cured to react the isocyanate and/or crosslink the copolymer in the latex composition, thereby increasing the tensile strength and elongation of the copolymer. In some embodiments, the asphalt emulsions can include vulcanizing (curing) agents, vulcanization accelerators, antireversion agents, or a combination thereof. In some embodiments, the vulcanizing agents, vulcanization accelerators, and/or antireversion agents can be included in the latex composition. Exemplary vulcanizing agents are sulfur curing agents and include various kinds of sulfur such as sulfur powder, precipitated sulfur, colloidal sulfur, insoluble sulfur and high-dispersible sulfur; sulfur halides such as sulfur monochloride and sulfur dichloride; sulfur donors such as 4,4′-dithiodimorpholine; selenium; tellurium; organic peroxides such as dicumyl peroxide and di-tert-butyl peroxide; quinone dioximes such as p-quinone dioxime and p,p′-dibenzoylquinone dioxime; organic polyamine compounds such as triethylenetetramine, hexamethylenediamine carbamate, 4,4′-methylenebis(cyclohexylamine) carbamate and 4,4′-methylenebis-o-chloroaniline; alkylphenol resins having a methylol group; and mixtures thereof. The vulcanizing agent can be present from 0.01 to 1% or from 0.01 to 0.6% by weight, based on the weight of the asphalt emulsion.

Exemplary vulcanization accelerators include sulfenamide-type vulcanization accelerators such as N-cyclohexyl-2-benzothiazole sulfenamide, N-t-butyl-2-benzothiazole sulfenamide, N-oxyethylene-2-benzothiazole sulfenamide, N-oxydiethylene-2-benzothiazole sulfenamide, N-oxydiethylene-thiocarbamyl-N-oxydiethylene sulfenamide, N-oxyethylene-2-benzothiazole sulfenamide and N,N-diisopropyl-2-benzothiazole sulfenamide; guanidine-type vulcanization accelerators such as diphenylguanidine, di-o-tolylguanidine and di-o-tolylbiguanidine; thiourea-type vulcanization accelerators such as thiocarboanilide, di-o-tolylthiourea, ethylenethiourea, diethylenethiourea, dibutylthiourea and trimethylthiourea; thiazole-type vulcanization accelerators such as 2-mercaptobenzothiazole, dibenzothiazyl disulfide, 2-mercaptobenzothiazole zinc salt, 2-mercaptobenzothiazole sodium salt, 2-mercaptobenzothiazole cyclohexylamine salt, 4-morpholinyl-2-benzothiazole disulfide and 2-(2,4-dinitrophenylthio)benzothiazole; thiadiazine-type vulcanization accelerators such as activated thiadiazine; thiuram-type vulcanization accelerators such as tetramethylthiuram monosulfide, tetramethylthiuram disulfide, tetraethylthiuram disulfide, tetrabutylthiuram disulfide and dipentamethylenethiuram tetrasulfide; dithiocarbamic acid-type vulcanization accelerators such as sodium dimethyldithiocarbamate, sodium diethyldithiocarbamate, sodium di-n-butyldithiocarbamate, lead dimethyldithiocarbamate, lead diamyldithiocarbamate, zinc diamyldithiocarbamate, zinc dimethyldithiocarbamate, zinc diethyldithiocarbamate, zinc di-n-butyldithiocarbamate, zinc pentamethylene dithiocarbamate, zinc ethylphenyldithiocarbamate, tellurium diethyldithiocarbamate, bismuth dimethyldithiocarbamate, selenium dimethyldithiocarbamate, selenium diethyldithiocarbamate, cadmium diethyldithiocarbamate, copper dimethyldithiocarbamate, iron dimethyldithiocarbamate, diethylamine diethyldithiocarbamate, piperidinium pentamethylene dithiocarbamate and pipecoline pentamethylene dithiocarbamate; xanthogenic acid-type vulcanization accelerators such as sodium isopropylxanthogenate, zinc isopropylxanthogenate and zinc butylxanthogenate; isophthalate-type vulcanization accelerators such as dimethylammonium hydrogen isophthalate; aldehyde amine-type vulcanization accelerators such as butyraldehyde-amine condensation products and butyraldehyde-monobutylamine condensation products; and mixtures thereof. The vulcanization accelerator can be present in an amount of from 0.01 to 1% or from 0.01 to 0.6% by weight, based on the weight of the asphalt formulation.

Antireversion agents can also be included to prevent reversion, i.e., an undesirable decrease in crosslink density. Suitable antireversion agents include zinc salts of aliphatic carboxylic acids, zinc salts of monocyclic aromatic acids, bismaleimides, biscitraconimides, bisitaconimides, aryl bis-citraconamic acids, bissuccinimides, and polymeric bissuccinimide polysulfides (e.g., N, N′-xylenedicitraconamides). The antireversion agent can be present in an amount of from 0.01 to 1% or from 0.01 to 0.6% by weight, based on the weight of the asphalt emulsion.

The asphalt emulsions can further include one or more additional additives. Suitable additional additives include chloride salts, thickeners, and fillers. Chloride salts can be added, for example to improve emulsifiability, in an amount of up to 1 part by weight. Suitable chloride salts include sodium chloride, potassium chloride, calcium chloride, aluminum chloride, or mixtures thereof. Thickeners can be added in an amount of 0.5 parts by weight or greater and can include associative thickeners, polyurethanes, alkali swellable latex thickeners, cellulose, cellulose derivatives, modified cellulose products, plant and vegetable gums, starches, alkyl amines, polyacrylic resins, carboxyvinyl resins, polyethylene maleic anhydrides, polysaccharides, acrylic copolymers, hydrated lime (such as cationic and/or nonionic lime), or mixtures thereof. In some embodiments, the asphalt emulsions described herein do not include a thickener. Mineral fillers and/or pigments can include calcium carbonate (precipitated or ground), kaolin, clay, talc, diatomaceous earth, mica, barium sulfate, magnesium carbonate, vermiculite, graphite, carbon black, alumina, silicas (fumed or precipitated in powders or dispersions), colloidal silica, silica gel, titanium oxides (e.g., titanium dioxide), aluminum hydroxide, aluminum trihydrate, satine white, magnesium oxide, hydrated lime, limestone dust, Portland cement, silica, alum, fly ash, or mixtures thereof. Fillers such as mineral fillers and carbon black can be included in an amount of up to 5 parts by weight or up to 2 parts by weight.

The asphalt emulsions can be combined with aggregate. The aggregate can be of varying sizes as would be understood by those of skill in the art. Any aggregate that is traditionally employed in the production of bituminous paving compositions can be used, including dense-graded aggregate, gap-graded aggregate, open-graded aggregate, reclaimed asphalt pavement, and mixtures thereof. In some embodiments, the aggregate can be provided in an amount of 1 to 90 parts by weight, based on 100 parts by weight of the asphalt emulsion. In some embodiments, the asphalt emulsions can include an aggregate in an amount of 90 parts or less, 85 parts or less, 80 parts or less, 75 parts or less, 70 parts or less, 65 parts or less, 60 parts or less, 55 parts or less, 50 parts or less, or 45 parts or less by weight, based on 100 parts by weight of the asphalt emulsions. In some embodiments, the asphalt emulsions can include an aggregate in an amount of 5 parts or greater, 10 parts or greater, 15 parts or greater, 20 parts or greater, 25 parts or greater, 30 parts or greater, 35 parts or greater, 40 parts or greater, 45 parts or greater, or 50 parts or greater by weight, based on 100 parts by weight of the asphalt emulsions.

In some embodiments, the asphalt emulsions can have a pH of 7 or less. For example, the asphalt emulsions can have a pH of 6.5 or less, 6 or less, 5.5 or less, 5 or less 4.5 or less 4 or less, 3.5 or less, 3 or less, or 2.5 or less. In some examples, the asphalt emulsions can have a pH of 1.5 or greater, 2 or greater, 2.5 or greater, 3 or greater, 3.5 or greater, 4 or greater, 4.5 or greater, 5 or greater, 5.5 or greater, 6 or greater, 6.5 or greater, or 7 or greater.

In some embodiments, the asphalt emulsions can have a pH of from 1.5 to 7, from 2 to 6.5, from 1.5 to 6, from 2 to 6, from 3 to 7, from 3 to 6.5, from 3 to 6, from 4 to 7, from 4 to 6.5, or from 4 to 6.

### Methods

Methods for preparing the asphalt emulsions described herein are also provided. As described herein, the asphalt emulsion can include an unmodified asphalt or can be derived from a polymer-modified asphalt emulsion. In some embodiments, the method can include preparing a latex composition for use in the polymer-modified asphalt emulsions. A latex composition can be prepared by polymerizing monomers, such as styrene monomers, butadiene monomers, and optionally additional monomers in an aqueous emulsion polymerization reaction at a suitable temperature. The polymerization can be carried out at low temperature (i.e., cold polymerization) or at high temperature method (i.e., hot polymerization). In some embodiments, polymerization can be carried out at low temperature such as 30° C. or less (for example from 2° C. to 30° C., 2° C. to 25° C., 5° C. to 30° C., or 5° C. to 25° C.). In some embodiments, polymerization can be carried out at high temperature such as from 40° C. or greater, 50° C. or greater, or 60° C. or greater. In some embodiments, the high temperature can be from 40° C. to 100° C., 40° C. to 95° C., or 50° C. to 90° C.

The polymerized polymer can be produced using either a continuous, semi-batch (semi-continuous) or batch process. In some examples, the polymer can be produced using a continuous method by continuously feeding one or more monomer streams, a surfactant stream, and an initiator stream to one or more reactors. The surfactant stream includes a surfactant and water and can, in some embodiments, be combined with the initiator stream.

The polymerization reaction can be conducted in the presence of molecular weight regulators to reduce the molecular weight of the copolymer of other additives such as dispersants, stabilizers, chain transfer agents, buffering agents, salts, preservatives, fire retardants, wetting agents, protective colloids, biocides, crosslinking promoters, antioxidants, antiozonants, prevulcanization inhibitors, and lubricants. In some embodiments, the additives can be added to the latex composition after the polymerization reaction. The latex composition can be agglomerated, e.g., using chemical, freeze or pressure agglomeration, and water removed to produce the desired solids content. In some embodiments, the solids content is 55% or greater, 60% or greater, or 65% or greater. In some embodiments, the latex composition can have an overall anionic charge, non-ionic, or cationic charge. One of ordinary skill in the art understands that the overall charge of the latex composition can be influenced by the surfactant used, the particular monomers used to form the polymer in the latex composition, and the pH of the latex composition.

The latex compositions can be used in asphalt emulsions prepared at temperatures below 120° C. (e.g., from 5° C. to less than 100° C., from 10° C. to 90° C., or from 20° C. to 85° C.). In some embodiments, the latex compositions can be used in asphalt emulsions prepared at less than 100° C., e.g., at ambient temperature, to produce a polymer-modified asphalt emulsion. The method of preparing the asphalt emulsions can include contacting asphalt with a latex composition as described herein.

The method of preparing the asphalt emulsions can include contacting asphalt (a modified or unmodified asphalt) with isocyanate and water to form an emulsion. The method can further include allowing the isocyanate to react with components in the asphalt emulsion. In some embodiments, the method can further include contacting the asphalt with a polyol and/or surfactant. In some examples, the isocyanate (e.g., polymeric MDI) can be blended and/or partially reacted with the polyol when used, prior to reacting with the asphalt. Alternately, the isocyanate can be blended and/or reacted with asphalt, followed by blending with the polyol to completely or substantially completely react with the remaining available isocyanate groups. The particular components, including the asphalt, the isocyanate, the latex composition, water, polyol, and/or the surfactant in the asphalt emulsions can be mixed together by any means known in the art. The particular components can be mixed together in any order.

As discussed herein, the isocyanate groups are very reactive and can react with groups that contain an active hydrogen atom (that might be on any of the components of the asphalt emulsion, such as the asphalt, the polymer, the additives, or other components that are present). The reaction between isocyanate and components of the asphalt emulsion can take place at ambient temperature but is facilitated by higher temperatures. In some embodiments, the method of preparing the asphalt emulsions can include post-adding the isocyanate to the modified or unmodified asphalt emulsion (including asphalt, water, optional surfactants, polyol, and such the like). For example, the method of preparing the asphalt emulsions can include mixing the isocyanate with the modified or unmodified asphalt emulsion, wherein the modified or unmodified asphalt emulsion comprises asphalt, water, and optionally one or more additional ingredients such as surfactants, polyols, and such the like. Thus, the isocyanate can be the last ingredient to be added to the modified or unmodified asphalt emulsion. In some examples, the isocyanate can be mixed with the modified or unmodified asphalt emulsion just before application of the asphalt emulsion to a surface, such as a road surface.

The particular components, including the asphalt, the isocyanate, water, the latex composition, polyol, and the surfactant can be fed into a colloid mill at a temperature of less than 100° C. (e.g., 60° C. to 95° C.) where high shear mixing produces an asphalt emulsion having asphalt droplets dispersed in the water. The isocyanate, water, surfactant, and/or the latex can be added simultaneously to asphalt or the latex and/or the isocyanate post-added to a mixture comprising asphalt, surfactant, and water. In some embodiments, the isocyanate, surfactant, water, and the latex composition are mixed with the asphalt sequentially. In some embodiments, the isocyanate can be combined directly with the asphalt prior to mixing with the other ingredients. In some embodiments, the latex composition and the surfactant are mixed with the asphalt simultaneously.

The droplets in the asphalt emulsion can have a narrow particle size distribution. In some embodiments, the droplets in the asphalt emulsion can have a median particle size of 15 μm or less, 14 μm or less, 13 μm or less, 12 μm or less, 11 μm or less, 10 μm or less, 9 μm or less, 8 μm or less, 7 μm or less, 6 μm or less, or 5 μm or less and/or of 5 μm or greater, 6 μm or greater, 7 μm or greater, 8 μm or greater, 9 μm or greater, or 10 μm or greater. In some embodiments, the droplets in the asphalt emulsion can have a mean particle size of 15 μm or less, 14 μm or less, 13 μm or less, 12 μm or less, 11 μm or less, 10 μm or less, 9 μm or less, 8 μm or less, 7 μm or less, 6 μm or less, or 5 μm or less and/or of 5 μm or greater, 6 μm or greater, 7 μm or greater, 8 μm or greater, 9 μm or greater, or 10 μm or greater. In some embodiments, the droplets in the asphalt emulsion can have a median particle size of from 3 to 15 μm. In some embodiments, the droplets in the asphalt emulsion can have a median distribution of droplet particles having a standard deviation of from 3 to 30 μm. In some embodiments, the droplets in the asphalt emulsion can have a standard deviation of 30 μm or less, 25 μm or less, 20 μm or less, 15 μm or less, 10 μm or less, or 5 μm or less, and/or of 3 μm or greater, 5 μm or greater, 7 μm or greater, 8 μm or greater, 9 μm or greater, 10 μm or greater, 15 μm or greater, 20 μm or greater, or 25 μm or greater. In some embodiments, the droplets in the asphalt emulsion can have a median distribution of droplet particles having a standard deviation of less than 30%, less than 25%, less than 20%, less than 15%, or less than 10%.

The asphalt emulsions can have a viscosity of 25 cp or greater, when the asphalt is present in an amount of 65% by weight, based on the asphalt emulsion, in the absence of a thickener. In the event the asphalt content is less than or greater than 65% by weight, the asphalt content can be adjusted by adding or removing water. In some embodiments, the asphalt emulsions can have a viscosity of 50 cp or greater, 75 cp or greater, 100 cp or greater, 150 cp or greater, 200 cp or greater, 250 cp or greater, 300 cp or greater, 350 cp or greater, 400 cp or greater, 450 cp or greater, 500 cp or greater, 600 cp or greater, 700 cp or greater, 800 cp or greater, 900 cp or greater, 1000 cp or greater, 1500 cp or greater, 2000 cp or greater, or 2500 cp or greater, at 60° C. as determined by Brookfield viscometer, spindle #3 and 20 rpm, when the asphalt is present in an amount of 65% by weight, based on the asphalt emulsion. In some embodiments, the asphalt emulsions can have a viscosity of 2500 cp or less, 2000 cp or less, 1500 cp or less, 1250 cp or less, 1000 cp or less, 950 cp or less, 900 cp or less, 850 cp or less, 800 cp or less, 750 cp or less, 700 cp or less, 650 cp or less, 600 cp or less, 550 cp or less, 500 cp or less, 400 cp or less, 250 cp or greater, 300 cp or less, 200 cp or less, 100 cp or less, or 50 cp or less, at 60° C. as determined by Brookfield viscometer, spindle #3 and 20 rpm, when the asphalt is present in an amount of 65% by weight, based on the asphalt emulsion. In some embodiments, the viscosity of the asphalt emulsions can be from 25 cp to 2500 cp, from 25 cp to 2000 cp, from 100 cp to 2500 cp, for example, from 100 cp to 2000 cp, 100 cp to 1500 cp, 100 cp to 1000 cp, 100 cp to 800 cp, 100 cp to 600 cp, 100 cp to 500 cp, 200 cp to 2000 cp, 200 cp to 1500 cp, 200 cp to 1000 cp, 200 cp to 800 cp, 200 cp to 600 cp, 200 cp to 500 cp, 100 cp to 450 cp, or 150 cp to 500 cp, at 60° C. as determined by Brookfield viscometer, spindle #3 and 20 rpm, when the asphalt is present in an amount of 65% by weight, based on the asphalt emulsion.

The isocyanate present in the asphalt emulsions can enhance the asphalt's softening to a level above that of the unmodified asphalt or a polymer-modified asphalt. As a result of the increased softening point, asphalt emulsions modified with the isocyanate as disclosed herein show improved performance. In some embodiments, the asphalt emulsion has a softening point that is 5° C. or greater, 10° C. or greater, or 15° C. or greater than the softening point of the same asphalt emulsion without the isocyanate. In some embodiments, the asphalt emulsion using a PG 58-28 base asphalt can have a softening point of 45° C. or greater (for example, 50° C. or greater, 55° C. or greater, 60° C. or greater, 65° C. or greater, 70° C. or greater, 75° C. or greater, or 80° C. or greater). In some embodiments, the asphalt emulsion using a PG 58-28 base asphalt can have a softening point of 85° C. or less (for example, 80° C. or less, 75° C. or less, or 70° C. or less). In some embodiments, the asphalt emulsion using a PG 58-28 base asphalt can have a softening point of from 50° C. to 85° C. or from 65° C. to 80° C. The Ring and Ball Softening Point test, such as those described in ASTM D36 and/or AASHTO T53, can be used to measure the temperature at which an asphalt composition becomes soft and flowable.

The asphalt emulsions, when dried, can have improved sweep performance. In some embodiments, the asphalt emulsion has an aggregate loss of less than 10% by weight (for example, 9% by weight or less, 8% by weight or less, 7% by weight or less, 6% by weight or less, 5% by weight or less, 4% by weight or less, or 3% by weight or less), as measured by the Sweep test two hours after drying. The sweep performance of the asphalt emulsion can be determined according to ASTM 7000.

The isocyanate present in the asphalt emulsions can enhance the asphalt's softening to a level above that of the unmodified asphalt. In some embodiments, the unmodified asphalt emulsion has an elastic recovery of 10% or greater. In some embodiments, the polymer modified asphalt emulsion has an elastic recovery of 60% or greater (for example, 65% or greater or 70% or greater. The elastic recoveries of the asphalt emulsions are measured using a ductilometer according to a modified ASTM D6084 Procedure B testing protocol or AASHTO T-301.

The isocyanate present in the asphalt emulsions can enhance the asphalt's recovery to a level above that of the unmodified asphalt or a polymer-modified asphalt. In some embodiments, the asphalt emulsion has a % recovery of at least 20 percentage points, compared to an identical asphalt emulsion not including the isocyanate, as measured by the Multiple Stress Creep Recovery test according to AASHTO T-350 or ASTM D7405. In some embodiments, an unmodified asphalt emulsion comprising a PG grade base asphalt and at least 2% by weight isocyanate has a % recovery of at least 30% (for example, at least 35%, at least 40%, at least 45%, at least 50%, at least 55%, or at least 60%) at the base asphalt high PG temperature and 100 Pa, as measured by the Multiple Stress Creep Recovery test according to AASHTO T-350 or ASTM D7405. In some embodiments, an unmodified asphalt emulsion comprising a PG grade base asphalt and at least 2% by weight isocyanate has a % recovery of at least 20 (for example, at least 22%, at least 25%, at least 28%, at least 30%, or at least 35%) at the base asphalt high PG temperature and 3200 Pa, as measured by the Multiple Stress Creep Recovery test according to AASHTO T-350 or ASTM D7405. In some embodiments, a modified asphalt emulsion comprising a PG grade base asphalt and at least 2% by weight isocyanate has a % recovery of at least 50% (for example, at least 55%, at least 60%, at least 65%, at least 70%, at least 75%, at least 80%, at least 85%, or at least 90%) at the base asphalt high PG temperature and 100 Pa, as measured by the Multiple Stress Creep Recovery test according to AASHTO T-350 or ASTM D7405. In some embodiments, a modified asphalt emulsion comprising a PG grade base asphalt and at least 2% by weight isocyanate has a % recovery of at least 40% (for example, at least 42%, at least 45%, at least 50%, at least 52%, at least 55%, at least 58%, or at least 60%) at the base asphalt high PG temperature and 3200 Pa, as measured by the Multiple Stress Creep Recovery test according to AASHTO T-350 or ASTM D7405.

For example, an unmodified asphalt emulsion comprising a PG grade base asphalt and at least 2% by weight isocyanate has a % recovery of at least 30% (for example, at least 35%, at least 40%, at least 45%, at least 50%, at least 55%, or at least 60%) at 58° C. and 100 Pa, as measured by the Multiple Stress Creep Recovery test according to AASHTO T-350 or ASTM D7405. In some embodiments, an unmodified asphalt emulsion comprising a PG grade base asphalt and at least 2% by weight isocyanate has a % recovery of at least 20% (for example, at least 22%, at least 25%, at least 28%, at least 30%, or at least 35%) at 58° C. and 3200 Pa, as measured by the Multiple Stress Creep Recovery test according to AASHTO T-350 or ASTM D7405. In some embodiments, a modified asphalt emulsion comprising a PG grade base asphalt and at least 2% by weight isocyanate has a % recovery of at least 50% (for example, at least 55%, at least 60%, at least 65%, at least 70%, at least 75, at least 80, at least 85, or at least 90) at 58° C. and 100 Pa, as measured by the Multiple Stress Creep Recovery test according to AASHTO T-350 or ASTM D7405. In some embodiments, a modified asphalt emulsion comprising a PG grade base asphalt and at least 2% by weight isocyanate has a % recovery of at least 40% (for example, at least 42%, at least 45%, at least 50%, at least 52%, at least 55%, at least 58%, or at least 60%) at 58° C. and 3200 Pa, as measured by the Multiple Stress Creep Recovery test according to AASHTO T-350 or ASTM D7405.

The asphalt emulsions comprising the isocyanate can have a performance grade (PG) increase of at least 1 PG or at least 2 PG above that of an identical asphalt emulsion without the isocyanate. The improvement can be a 1 PG or more improvement in the fresh Strategic Highway Research Program (SHRP) high temperature, the Rolling Thin-Film Oven (RTFO) SHRP high temperature, or both. An unmodified standard NUSTAR 64-22 asphalt without isocyanate has an SHRP High Temperature of 64° C. Performance Grade improvements are measured in increments of 6° C. Accordingly, an asphalt emulsion comprising NUSTAR 64-22 and isocyanate having an SHRP High Temperature of 70° C. would be 1 PG improvement over the comparative, standard NUSTAR 64-22 without the isocyanate. Similarly, an asphalt emulsion comprising NUSTAR 64-22 and an isocyanate having an SHRP High Temperature of 76° C. would be 2 PG improvements over the comparative, standard NUSTAR 64-22 without the polymer. In some embodiments, an unmodified asphalt emulsion comprising at least 2% by weight isocyanate as described herein has a fresh SHRP high temperature of 70° C. or greater, 76° C. or greater, 82° C. or greater, or 88° C. or greater. In some embodiments, a polymer-modified asphalt emulsion comprising at least 2% by weight isocyanate as described herein has a fresh SHRP high temperature of 76° C. or greater, 82° C. or greater, 88° C. or greater, or 94° C. or greater. The Strategic Highway Research Program (SHRP) evaluation of the asphalts emulsions can be carried out according to the ASTM D7175 or AASHTO T315 procedure following Rolling Thin-Film Oven (RTFO) exposure. The Dynamic Shear Rheometer (DSR) tests measure the dynamic shear modulus and stiffness of the asphalt emulsions. Testing of the original (unaged or fresh) asphalt emulsions and of the asphalt emulsions after RTFO exposure provided the High Temperature in the Performance Grade (PG) scale.

The asphalt emulsions described herein can adhere to the standards of ASTM D977, ASTM D2397, AASHTO M140, and AASHTO M208.

Methods of using the asphalt emulsions described herein are disclosed. The asphalt emulsion can be applied to a surface to be treated, restored, or sealed. Prior to application of the asphalt emulsion, the surface to be treated is usually cleaned to remove excess surface dirt, weeds, and contaminants by, for example, brushing the surface, blasting the surface with compressed air, or washing the surface. The asphalt emulsion can be applied using any suitable method for applying a liquid to a porous surface, such as brushing, wiping and drawing, or spraying.

In some embodiments, the asphalt emulsion, once applied, wet the surface thereby forming a layer on at least a portion and typically at least a substantial portion (e.g. more than 50%) of the surface. In some embodiments, when asphalt emulsions are applied to a surface, water loss occurs in the emulsion, primarily due to adsorption of the water. The water also delivers the asphalt emulsions to the surface. In some embodiments, the asphalt emulsion penetrates and adheres to the surface it is applied to, cures in a reasonably rapid time, and provides a water-tight and air-tight barrier on the surface. The asphalt emulsion layer also promotes adhesion between the older surface and the later applied surface treatment layer. It is desirable for the asphalt emulsion to be easily applied and have an adequate shelf life.

An aggregate can be blended into the asphalt emulsion before application to a surface. In some embodiments, the aggregate can be applied to the asphalt emulsion after it is applied to a surface. For example, sand can be applied to the asphalt emulsion after it is applied to a surface, for example, if the emulsion is to be used as a tack coat, to reduce the tackiness of the surface. The asphalt emulsion and optionally the aggregate can be compacted after application to the surface as would be understood by those of skill in the art.

The asphalt emulsion can be applied for use in a pavement or paved surface. A pavement surface or a paved surface is a hard surface that can bear pedestrian or vehicular travel can include surfaces such as motorways/roads, parking lots, bridges/overpasses, runways, driveways, vehicular paths, running paths, walkways, and the like. The asphalt emulsion can be applied directly to an existing paved surface or can be applied to an unpaved surface. In some embodiments, the asphalt emulsion can be applied to an existing paved layer as a tie layer, and a new layer comprising asphalt such as a hot mix layer is applied to the tie layer. The asphalt emulsion can be applied to a surface “cold,” i.e., at a temperature below 40° C., or can be applied to at an elevated temperature, for example, from 50° C. to 120° C., from 55° C. to 100° C., or from 60° C. to 80° C.

The asphalt emulsions can be used in waterproofing applications, involving vertical or horizontal substrates, in above-grade and below-grade applications. In some embodiments, the asphalt emulsion can be used as a tack coat or coating. The tack coat is a very light spray application of diluted asphalt emulsion that can be used to promote a bond between an existing surface and the new asphalt application. The tack coat acts to provide a degree of adhesion or bonding between asphalt layers, and in some instances, can fuse the layers together. The tack coat also acts to reduce slippage and sliding of the layers relative to other layers in the pavement structure during use or due to wear and weathering of the pavement structure. In some embodiments, the asphalt emulsion can be applied to an existing paved layer (such as a hot-mix layer) as a tack coat, and a new layer comprising asphalt such as a hot-mix layer can be applied to the tack coat. As would be understood by those skilled in the art, the tack coat typically does not include aggregate, although sand may be applied to the tack coat after application as mentioned herein.

In some embodiments, the asphalt emulsion can also be used as a fog seal. A fog seal is a surface treatment that applies a light application of the emulsion to an existing paved surface such as a parking lot to provide an enriched pavement surface that looks fresh and black. In some embodiments, the fog seal would include a filler such as carbon black to blacken the emulsion. As would be understood by those skilled in the art, the fog seal might not include aggregate. The fog seal emulsion, like the bond coat emulsion, have also been shown to be to be low-tracking or “trackless” coatings.

In some embodiments, the asphalt emulsion can be used as a chip seal composition. Chip seals are the most common surface treatment for low-volume roads. The chip seal emulsion can be applied to a surface followed by the application of aggregate. In some embodiments, the asphalt emulsion can be used in a microsurfacing application. Microsurfacing is designed for quick traffic return with the capacity of handling high traffic volume roadways. For the microsurfacing emulsion, aggregate can be mixed in with a cationic asphalt emulsion before application to a surface.

In some embodiments, the asphalt emulsion can be used in paints, coatings, paper coating or binding compositions, carpet compositions (e.g., carpet backing), foams, or adhesives.

By way of non-limiting illustration, examples of certain embodiments of the present disclosure are given below.

### EXAMPLES

Example 1: Isocyanate-Modified Asphalt Emulsions

This example demonstrates that asphalt emulsions and polymer-modified asphalt emulsion each comprising a polyisocyanate exhibit enhanced performance compared to an identical emulsion in the absence of the polyisocyanate.

Method: Asphalt emulsions were blended as described in Table 1 below. When used, the isocyanate was polymethylene polyphenylisocyanate. Associated Asphalt PG 58-28 was used for Controls A and B and Samples 1A, 1B, 2A, 2B, 3A, and 3B. Another PG 58-28 asphalt was used for Control C and Samples 1C, 2C, 2D, and 3C. 0.3% Indulin AA-86 was used as emulsifier in each sample. Butonal NX 4190 was used as latex modifier. Several properties of the asphalt emulsions were determined as described in Tables 1 and 2 below.

Results: Several properties of the asphalt emulsions are described in Tables 1 and 2 below.

TABLE 1
Asphalt Emulsions

| | | Latex | | Mass | Elastic | Penetration | Softening |
|---|---|---|---|---|---|---|---|
| | Asphalt | Modifier | Isocyanate | Loss¹ | Recovery² | Grade³ at | Point⁴ |
| Sample | (%) | (%) | (%) | (%) | (%) | 25° C. | (° F.) |
| Control A⁺ | 67 | 0 | 0 | 30.9 | 9.4 | 84.7 | 114.7 |
| Control B* | 67 | 0 | 0 | — | — | — | — |
| Control C* | 67 | 0 | 0 | 16.8 | — | — | — |
| 1A⁺ | 67 | 0 | 2 | 31.2 | 14.4 | 58.7 | 124.7 |
| 1B* | 67 | 0 | 2 | — | — | — | — |
| 1C* | 67 | 0 | 2 | 8.46 | — | — | — |
| 2A⁺ | 69.8 | 3 | 0 | 4.05 | 70.6 | 70.7 | 156.2 |
| 2B* | 69.8 | 3 | 0 | — | — | — | — |
| 2C* | 69.8 | 3 | 0 | — | — | — | — |
| 2D* | 69.8 | 4 (post | 0 | — | — | — | — |
| | | addition) | | | | | |
| 3A⁺ | 69.8 | 3 | 2 | 3.53 | 60.0 | 44.0 | 165.1 |
| 3B* | 69.8 | 3 | 2 | — | — | — | — |
| 3C* | 69.8 | 3 | 2 | 5.23 | — | — | — |

⁺Recovery at 163° C. in oven, ASTM 6934.
*Low temperature recovery using 60 grams silicon mold 24 hrs then 60° C. in oven for 24 hrs.
¹Mass loss was determined using the sweep test at 2 hours (ASTM D7000).
²Elastic Recovery was determined at ER 10° C. SS 20 cm 5 mn using ASTM D6084 Procedure B. The reported values are an average from two tests.
³Penetration was determined using ASTM D 5. The reported values are an average from three tests.
⁴Softening Point was determined using ASTM D36. The reported values are an average from two tests.

TABLE 2
Properties of Asphalt Emulsions

| | | MSCR⁶ | MSCR⁶ | MSCR⁶ | MSCR⁶ |
|---|---|---|---|---|---|
| | | at 58° C. | at 64° C. | at 58° C. | at 64° C. |
| | SHRP | and 100 | and 100 | and 3200 | and 3200 |
| Sample | Grade⁵ | Pa | Pa | Pa | Pa |
| Control B* | 64.3 | 5.6 | 0.5 | 1.8 | −0.4 |
| Control C* | 66.3 | 4.6 | 0.8 | 1.8 | −0.2 |
| 1B* | 77.8 | 39.6 | 23.1 | 28.7 | 8.5 |
| 1C* | 80 | 47 | 32.7 | 47.8 | 14.4 |
| 2B* | 70.2 | 43.7 | 20.2 | 50.8 | 15 |
| 2D* | 91.5 | 73.3 | 60.2 | 57.1 | 45 |
| 3B* | 87.5 | 75.3 | 55.9 | 59.5 | 39.2 |
| 3C* | 92.9 | 73.1 | 60.5 | 60.7 | 45.6 |

⁵fresh SHRP high temperature was determined using ASTM D7175 or AASHTO T315.
⁶Multiple Stress Creep Recovery (MSCR) was determined using AASHTO T-350 or ASTM D7405.

Summary: The viscoelastic properties (asphalt exhibiting both viscous and elastic properties when undergoing deformation) of asphalt are important performance characteristics. It has been shown that the presence of isocyanate in an otherwise unmodified asphalt emulsion or in an asphalt emulsion modified with Butonal 4190 (SBR latex) exhibited improved performance in comparison to the same asphalt emulsions containing no isocyanate. In particular, High Temperature SHRP, MSCR (multiple stress creep recovery) percent recovery at 100 Pa and 3200 Pa and at both 58° C. and 64° C., elastic recovery at 10° C., softening point, and penetration were significant improved for asphalt emulsions comprising isocyanate, with or without polymer modification with Butonal 4190. The sweep results for the asphalt emulsions was also improved for the polyisocyanate/ Butonal 4190 modified asphalt emulsion, as shown in Table 2.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1.-59. (canceled)

60. An asphalt emulsion comprising:
asphalt present in an amount of 50% by weight or greater, based on the weight of the asphalt emulsion,
an isocyanate present in an amount of 0.05% by weight or greater, based on the weight of the asphalt emulsion, and
water.

61. The asphalt emulsion of claim 60, wherein the asphalt is present in an amount of from 50% to 99% by weight, based on the weight of the asphalt emulsion.

62. The asphalt emulsion of claim 60, wherein the isocyanate is an oligomer, a polymer, or a blend thereof.

63. The asphalt emulsion of claim 60, wherein the isocyanate has a molecular weight of from 100 Da to 250,000 Da.

64. The asphalt emulsion of claim 60 wherein the isocyanate has a functionality of 1.5 or greater.

65. The asphalt emulsion of claim 60, wherein the isocyanate is a polymer derived from methylene diphenyl diisocyanate, toluene diisocyanate, phenylene diisocyanate, tetramethylene diisocyanate, hexamethylene diisocyanate, dicyclohexylmethane diisocyanate, isophorone diisocyanate, triphenylmethane triisocyanate, naphthalene 1,5-diisocyanate (NDI), naphthalene 1,4-diisocyanate (NDI), xylylene diisocyanate (XDI), tetraalkyl-diphenylmethane dlisocyanates, 4,4′-diphenyl-dimethylmethane diisocyanate, dibenzyl diisocyanate, benzene triisocyanate, 4,4′-dicyclohexylmethane diisocyanate (H₁₂MDI), 1-isocyanatomethyl-3-isocyanato-1,5,5-trimethyl-cyclohexane (isophorone diisocyanate, IPDI), cyclohexane 1,4-diisocyanate, hydrogenated xylylene diisocyanate (H₆XDI), 1-methyl-2,4-diisocyanato-cyclohexane, m- or p-tetramethylxylene diisocyanate (m-TMXDI, p-TMXDI), tetramethoxybutane 1,4-diisocyanate, butane 1,4-diisocyanate, hexane 1,6-diisocyanate (HDI), 1,6-diisocyanato-2,2,4-trimethylhexane, 1,6-diisocyanato-2,4,4-trimethylhexane, lysine diisocyanate, 1,12-dodecane diisocyanate (C₁₂CDI)_{y}, or mixtures thereof.

66. The asphalt emulsion of claim 60, wherein the isocyanate comprises an aromatic group.

67. The asphalt emulsion of claim 60, wherein the isocyanate reacts with the asphalt to form a polymer network in the asphalt emulsion.

68. The asphalt emulsion of claim 60, wherein the isocyanate is present in an amount from 0.05% to 45%, based on the weight of the asphalt emulsion.

69. The asphalt emulsion of claim 60, wherein the asphalt includes an unmodified asphalt.

70. The asphalt emulsion of claim 60, wherein the asphalt emulsion further comprises a copolymer derived from one or more ethylenically unsaturated monomers selected from the group consisting of styrene, butadiene, meth(acrylate) monomers, vinyl acetate, vinyl ester monomers, and combinations thereof.

71. The asphalt emulsion of claim 70, wherein the copolymer includes a styrene-butadiene copolymer, polychloroprene, a styrene-butadiene-styrene copolymer, an ethylene vinyl acetate copolymer, or a combination thereof.

72. The asphalt emulsion of claim 70, wherein the copolymer includes a styrene-butadiene copolymer and/or a styrene-butadiene-styrene copolymer and the styrene and butadiene are in a weight ratio of styrene to butadiene of from 20:80 to 80:20.

73. The asphalt emulsion of claim 70, wherein the copolymer is further derived from one or more carboxylic acid monomers.

74. The asphalt emulsion of claim 73, wherein the copolymer comprises from 0.5% to 10% by weight carboxylic acid monomers.

75. The asphalt emulsion of claim 73, wherein the carboxylic acid monomers are selected from itaconic acid, fumaric acid, acrylic acid, methacrylic acid, crotonic acid, and combinations thereof.

76. The asphalt emulsion of claim 70, wherein the copolymer has a glass transition temperature of from −80° C. to 110° C.

77. The asphalt emulsion of claim 70, wherein the copolymer is present in an amount of 0.5% by weight or greater, based on the weight of the asphalt emulsion.

78. The asphalt emulsion of claim 60, wherein the asphalt emulsion further comprises a polyol.

79. The asphalt emulsion of claim 78, wherein the polyol includes a polyalkylene glycol.
